(19) United States
(12) Patent Application Publication
(10) Pub. No.: US 2019/0025644 A1
(43) Pub. Date: Jan. 24, 2019

(54) DISPLAY PANEL AND DISPLAY DEVICE

(71) Applicant: BOE TECHNOLOGY GROUP CO., LTD,, Beijing (CN)

(72) Inventors: Jifeng TAN, Beijing (CN); Wei WANG, Beijing (CN); Yafeng YANG, Beijing (CN); Dacheng ZHANG, Beijing (CN)

(21) Appl. No.: 15/756,413

(22) PCT Filed: Jul. 31, 2017
(86) PCT No.: PCT/CN2017/095227

§ 371 Date: Feb. 28, 2018

(30) Foreign Application Priority Data
Oct. 28, 2016 (CN) 201610964413.0

(51) Int. Cl. G02F 1/1335; G02F 1/1343; G09G 3/36; G02B 6/122

(52) U.S. Cl. CPC G02F 1/133602; G02B 6/1223; G09G 3/3607; G02F 1/1343

(57) ABSTRACT

A display panel and a display device are disclosed. The display panel includes a first substrate, a liquid crystal layer, a waveguide layer, a grating layer, a first electrode and a second electrode. The liquid crystal layer, the first electrode and the second electrode are located between the waveguide layer and the first substrate. The first electrode and the second electrode are configured to adjust a refractive index of the liquid crystal layer by changing voltages applied thereto, wherein an amount of light coupled out of the waveguide layer is determined based on a difference between the refractive index of the liquid crystal layer and a refractive index of the waveguide layer.

### CROSS-REFERENCE TO RELATED APPLICATIONS

This is a National Phase Application filed under 35 U.S.C. 371 as a national stage of PCT/CN2017/095227, filed on Jul. 31, 2017, an application claiming the priority of Chinese Patent Application No. 201610964413.0, filed on Oct. 28, 2016, the contents of which are incorporated herein in their entirety by reference.

### TECHNICAL FIELD

The present disclosure relates to the field of display technology, and particularly relates to a display panel and a display device.

### BACKGROUND

In the field of display technology, a liquid crystal display device includes a backlight and a display panel. The display panel includes an array substrate and a color filter substrate provided opposite to each other, a liquid crystal layer is provided between the array substrate and the color filter substrate, and the array substrate and the color filter substrate each are provided with a polarizer on the back. Grayscale display is achieved through deflection of liquid crystals controlled by a voltage and control of the two polarizers.

In the prior art, color resists in the color filter substrate may be made of a resin material doped with a dye.

The use of a polarizer in a display panel of a liquid crystal display device in the prior art may result in a low transmittance of the liquid crystal display device (for example, a transmittance of about 7%) and a large liquid crystal cell thickness (for example, 3 μm to 5 μm), and a large cell thickness may reduce response speed of liquid crystal. Due to poor filtering effect of a dye itself in the prior art, the color resists made of a resin doped with the dye will render a liquid crystal display device with a low transmittance.

### SUMMARY

The present disclosure provides a display panel, including a first substrate, a liquid crystal layer, a waveguide layer, a grating layer, a first electrode and a second electrode, wherein the liquid crystal layer, the first electrode and the second electrode are located between the waveguide layer and the first substrate;

the first electrode and the second electrode are configured to adjust a refractive index of the liquid crystal layer by changing voltages applied thereto;

wherein an amount of light coupled out of the waveguide layer is determined based on a difference between the refractive index of the liquid crystal layer and a refractive index of the waveguide layer.

Optionally, the display panel further includes a second substrate located on a side of the waveguide layer distal to the first substrate.

Optionally, the second electrode is on a side of the waveguide layer proximal to the first substrate, the grating layer is on a side of the first electrode proximal to the second substrate, the liquid crystal layer is on a side of the grating layer proximal to the second substrate, and the first electrode is on a side of the first substrate proximal to the second substrate.

Optionally, the grating layer includes a plurality of grating structures provided at intervals, the liquid crystal layer covers the grating structures and fills gaps between the grating structures, and the liquid crystal layer has a thickness greater than a thickness of the grating structures.

Optionally, the second electrode is on a side of the waveguide layer proximal to the first substrate, the first electrode is on a side of the first substrate proximal to the second substrate, the liquid crystal layer is between the first electrode and the second electrode, and the grating layer is on a side of the first substrate distal to the second substrate.

Optionally, the display panel further includes a planarization layer provided on a side of the grating layer distal to the first substrate;

wherein the grating layer comprises a plurality of grating structures provided at intervals, the planarization layer covers the grating structures and fills gaps between the grating structures, and the planarization layer has a thickness greater than a thickness of the grating structures.

Optionally, in a case where an absolute value of the difference between the refractive index of the waveguide layer and the refractive index of the liquid crystal layer is a first set difference value, the amount of light coupled out of the waveguide layer is a set amount, so that the display panel is in L255 grayscale state; or

in a case where the absolute value of the difference between the refractive index of the waveguide layer and the refractive index of the liquid crystal layer is a second set difference value, the amount of light coupled out of the waveguide layer is zero, so that the display panel is in L0 grayscale state; or

in a case where the absolute value of the difference between the refractive index of the waveguide layer and the refractive index of the liquid crystal layer is larger than the first set difference value and smaller than the second set difference value, the amount of light coupled out of the waveguide layer is larger than zero and smaller than the set amount, so that the display panel is in a grayscale state other than the L0 grayscale state and L255 grayscale state.

Optionally, the grating layer includes a plurality of grating structures provided at intervals, the display panel comprises a plurality of pixel units, each of the plurality of pixel units comprises a plurality of grating structures, and the plurality of grating structures in each of the plurality of pixel units are configured to set an emergent angle of light having a specific wavelength by setting a grating period thereof.

Optionally, a zero-order diffraction intensity and a first-order diffraction intensity of the grating structures in each of the plurality of pixel units are determined according to a thickness and/or duty ratio of the grating structures.

The present disclosure provides a display device, including a backlight and the display panel described above.

### BRIEF DESCRIPTION OF THE DRAWINGS

FIG. 1 is a schematic structural diagram of a display panel according to a first embodiment of the present disclosure;

FIG. 2 is a schematic diagram of a waveguide layer in FIG. 1;

FIG. 3 is a diagram illustrating an optical path of the waveguide layer in FIG. 2;

FIG. 4 is a schematic diagram showing emergent light from the display panel of FIG. 1;

FIG. 5 is a schematic diagram illustrating diffraction principle of the grating layer in FIG. 1;

FIG. 6 is a schematic diagram illustrating interference principle of the grating layer in FIG. 1;

FIG. 7 is a schematic structural diagram of a display panel according to a second embodiment of the present disclosure;

FIG. 8 is a schematic structural diagram of a display device according to a third embodiment of the present disclosure;

FIG. 9a is a schematic diagram of a display device, which is an ECB display device, in a display mode; and

FIG. 9b is a schematic diagram of a display device, which is an ECB display device, in another display mode.

### DETAILED DESCRIPTION

To enable those skilled in the art to better understand technical solutions of the present disclosure, a display panel and a display device provided in the present disclosure will be described in detail below in conjunction with the accompanying drawings.

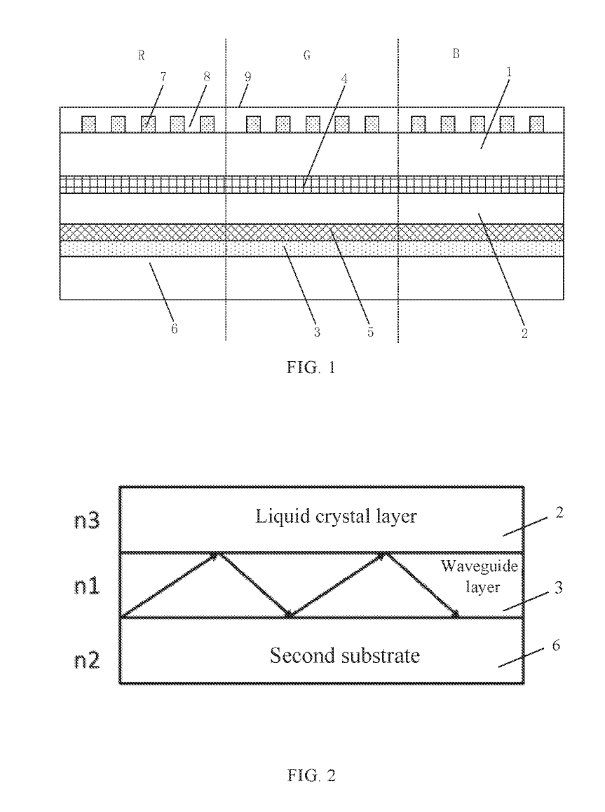

FIG. 1 is a schematic structural diagram of a display panel according to a first embodiment of the present disclosure. As shown in FIG. 1, the display panel includes a first substrate 1, a liquid crystal layer 2, a waveguide layer 3, a grating layer, a first electrode 4 and a second electrode 5. The liquid crystal layer 2, the first electrode 4 and the second electrode 5 are positioned between the waveguide layer 3 and the first substrate 1. The first electrode 4 and the second electrode 5 are configured to adjust a refractive index of the liquid crystal layer 2 by changing voltages applied thereon. The amount of light coupled out of the waveguide layer 3 is determined according to a difference between a refractive index of the waveguide layer 3 and the refractive index of the liquid crystal layer 2. The grating layer includes a plurality of grating structures arranged at intervals, and the grating structures in each pixel unit are configured to set an emergent angle of light having a specific wavelength by setting a grating period thereof.

In the embodiment, the amount of light coupled out from the waveguide layer 3 changes as the difference between the refractive index of the waveguide layer 3 and the refractive index of the liquid crystal layer 2 changes. Since the refractive index of the liquid crystal layer 2 can be adjusted according to a voltage difference between the voltages applied to the first electrode 4 and the second electrode 5, the refractive index of the liquid crystal layer 2 changes when the difference between the voltages applied to the first electrode 4 and the second electrode 5 changes, and accordingly the difference between the refractive index of the waveguide layer 3 and the refractive index of the liquid crystal layer 2 changes as well, so that the amount of light that is coupled out of the waveguide layer 3 changes.

Further, the display panel may also include a second substrate 6 positioned at a side of the waveguide layer 3 distal to the first substrate 1. In the embodiment, when the display panel does not include the second substrate 6, the waveguide layer 3 may also function as a second substrate 6, that is, the waveguide layer 3 and the second substrate 6 may be functionally integrated.

The second substrate 6 may be made of glass or a resin, and the first substrate 1 may be made of glass or a resin. In practical applications, the second substrate 6 and the first substrate 1 may be made of other material, which is not listed herein one by one.

In the embodiment, the first electrode 4 and the second electrode 5 may be located on one side or on different sides of the liquid crystal layer 2. Optionally, the first electrode 4 may be a common electrode and the second electrode 5 may be a pixel electrode.

As shown in FIG. 1, the first electrode 4 and the second electrode 5 are located on different sides of the liquid crystal layer 2. Specifically, the second electrode 5 is on a side of the waveguide layer 3 proximal to the first substrate 1, and the first electrode 4 is on a side of the first substrate 1 proximal to the second substrate 6, the liquid crystal layer 2 is between the first electrode 4 and the second electrode 5, and the grating layer is on a side of the first substrate 1 distal to the second substrate 6.

As shown in FIG. 1, in a case where the first electrode 4 and the second electrode 5 are located on different sides of the liquid crystal layer 2, the display panel may be a Twisted Nematic (TN) display panel, a Vertical Alignment (VA) display panel, or an Electrically Controlled Birefringence (ECB) display panel.

Alternatively, in a case where the first electrode 4 and the second electrode 5 are located on one side of the liquid crystal layer 2 and located in different layers, the display panel may be an Advanced Super Dimension Switch (ADS) display panel; in a case where the first electrode 4 and the second electrode 5 are located on one side of the liquid crystal layer 2 and located in one layer, the display panel may be an In-Plane Switching (IPS) display panel, which are not specifically illustrated herein. In practical applications, the display panel may also be any other type of display panel, which is not listed herein one by one.

The liquid crystal layer 2 may be made of a nematic liquid crystal, a cholesteric liquid crystal, or a blue-phase liquid crystal. Optionally, a TN display panel, a VA display panel and an ADS display panel generally employ a nematic liquid crystal.

The waveguide layer 3 may be made of a transparent material, for example, silicon nitride Si₃N₄. The waveguide layer 3 needs to have a refractive index greater than a refractive index of one or more layers adjacent to the waveguide layer 3 to ensure that light is totally reflected in the waveguide layer 3. As shown in FIG. 1, the refractive index of the waveguide layer 3 is greater than a refractive index of the second substrate 6, the refractive index of the waveguide layer 3 is greater than a refractive index of the second electrode 5, and the refractive index of the waveguide layer 3 is greater than the refractive index of the liquid crystal layer 2. The refractive index of the liquid crystal layer 2 is adjusted such that the refractive index of the liquid crystal layer 2 changes in a range of nₒ to nₑ (for example, nₑ is greater than nₒ). When the refractive index of the liquid crystal layer 2 is nₒ, an absolute value of the difference between the refractive index of the waveguide layer 3 and the refractive index of the liquid crystal layer 2 is a maximum difference value. When the refractive index of the liquid crystal layer 2 is nₑ, the absolute value of the difference between the refractive index of the waveguide layer 3 and the refractive index of the liquid crystal layer 2 is a minimum difference value.

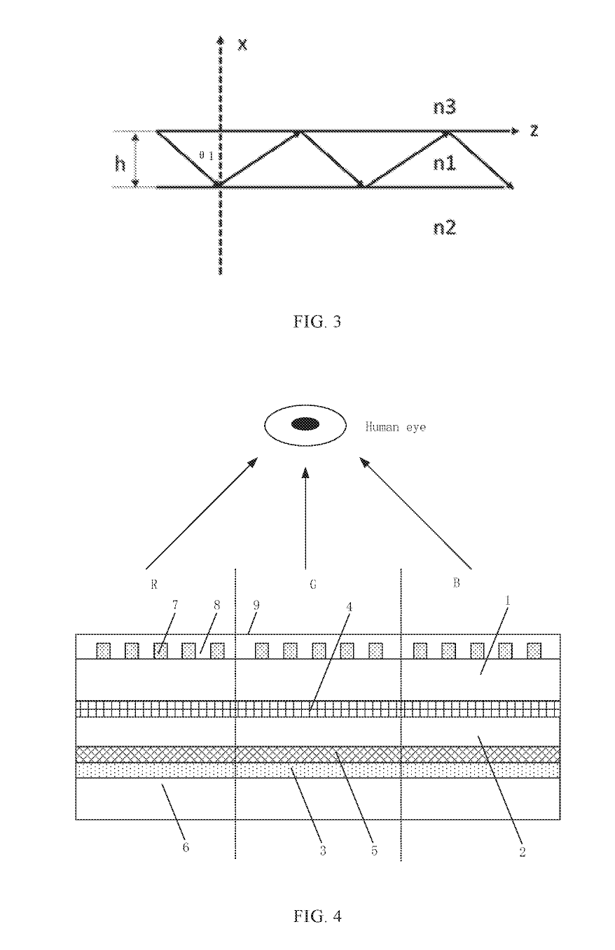

Since the refractive index of the waveguide layer 3 is greater than the refractive index of the second substrate 6 and the refractive index of the waveguide layer 3 is greater than the refractive index of the second electrode 5, light in the second electrode 5 and the second substrate 6 cannot be well confined, and is injected into the waveguide layer 3, and thus the second electrode 5 and the second substrate 6 function as an auxiliary waveguide. FIG. 2 is a schematic diagram of a waveguide layer in FIG. 1, FIG. 3 is a diagram illustrating an optical path of the waveguide layer in FIG. 2, and it needs to be noted that the second electrode is not shown in FIG. 2. As shown in FIGS. 2 and 3, the second substrate 6, the waveguide layer 3 and the liquid crystal layer 2 form a planar waveguide, the refractive index of the second substrate 6 is n₂, the refractive index of the waveguide layer 3 is n₁ and the refractive index of the liquid crystal layer 2 is n₃ The thickness of the waveguide layer 3 is typically micron-sized, and can be comparable to the wavelength of light. A difference between refractive indices of the waveguide layer 3 and the second substrate 6 may be between 10⁻¹ and 10⁻³. In order to form a true optical waveguide, n₁ must be greater than n₂ and n₃, that is, n₁>n₂≥n₃, and in this way, light can be limited to propagate in the waveguide layer 3. Propagation of light in a planar waveguide can be considered as that light is totally reflected at an interface between the waveguide layer 3 and the second substrate 6 and at an interface between the waveguide layer 3 and the liquid crystal layer 2, and propagates along a zigzag path in the waveguide layer 3. In the planar waveguide, n₁>n₂ and n₁>n₃, when an incident angle θ₁ of incident light exceeds the critical angle θ₀:

$$sin {θ}_{0} = \frac{{n}_{2}}{{n}_{1}}$$

the incident light is totally reflected, and at this point, a certain phase jump is produced at the reflection point. From Fresnel reflection formula:

$${R}_{TE} = \frac{{n}_{1} cos {θ}_{1} - \sqrt{{n}_{2}^{2} - {n}_{1}^{2} {sin}^{2} {θ}_{1}}}{{n}_{1} cos {θ}_{1} + \sqrt{{n}_{2}^{2} - {n}_{1}^{2} {sin}^{2} {θ}_{1}}} ;$$

$${R}_{TM} = \frac{{n}_{2}^{2} cos {θ}_{1} - {n}_{1} \sqrt{{n}_{2}^{2} - {n}_{1}^{2} {sin}^{2} {θ}_{1}}}{{n}_{2}^{2} cos {θ}_{1} + {n}_{1} \sqrt{{n}_{2}^{2} - {n}_{1}^{2} {sin}^{2} {θ}_{1}}} ,$$

it can be derived that the phase jumps ϕ_{TM}, ϕ_{TE}, at the reflection point are:

$$tan {φ}_{TE} = \frac{\sqrt{{β}^{2} - {k}_{0}^{2} {n}_{2}^{2}}}{\sqrt{{k}_{0}^{2} {n}_{1}^{2} - {β}^{2}}} ;$$

$$tan {φ}_{TM} = \frac{{n}_{1}^{2} \sqrt{{β}^{2} - {k}_{0}^{2} {n}_{2}^{2}}}{{n}_{2}^{2} \sqrt{{k}_{0}^{2} {n}_{1}^{2} - {β}^{2}}} ;$$

where β=k₀n₁ sin θ₁, β is a propagation constant of light, k₀=2πλ, k₀ is a wave number of light in vacuum, and λ is the wavelength of light. In order that light propagates stably in the waveguide layer 3, the following equation needs to be satisfied:

2kh−2ϕ₁₂−2ϕ₁₃=2mπ, m=0,1,2,3 . . . ;
where k=k₀n₁ cos θ, ϕ₁₂ and ϕ₁₃ are phase differences of total reflection, h is the thickness of the waveguide layer 3, m is a mode order, that is, a positive integer starting from zero. Therefore, only light having an incident angle satisfying the above equation can stably propagate in the optical waveguide, and the above equation is a dispersion equation for a planar waveguide.

As shown in FIG. 1, the grating layer includes a plurality of grating structures 7 disposed at intervals, with gaps 8 disposed between the grating structures 7. Specifically, the grating structures 7 may be made of a transparent medium, for example, silicon dioxide (SiO₂) or other organic resin, and the organic resin may include an organic polymer material such as Polymethylmethacrylate (PMMA). The grating structures 7 have a thickness smaller than or equal to 200 nm. The grating layer is a nano-scale grating layer.

Further, the display panel may also include a planarization layer 9 provided on a side of the grating layer distal to the first substrate 1. Specifically, the planarization layer 9 covers the grating structures 7 and fills the gaps 8 between the grating structures 7, and has a thickness greater that the thickness of the grating structures 7. The grating structures 7 and the planarization layer 9 may have a fixed difference in refractive indices, for example, the fixed difference between the refractive indices of the grating structures 7 and the planarization layer 9 may be greater than 0.05. It is preferred that the fixed difference in refractive indices is as large as possible, to facilitate the function of the grating structures 7. In practical applications, the thickness of the grating structures 7 can be set as required. For example, the grating structures 7 corresponding to a red pixel unit, a green pixel unit and a blue pixel unit may have a same thickness or different thicknesses. Optionally, the grating structures 7 may have a duty ratio of 0.5, but in practical design of product, the duty ratio may be set as required, for example, for the purpose of adjusting intensity of emergent light or balancing differences in brightness among different positions of the display panel.

Further, optionally, the display panel may also include alignment films (not illustrated) provided at both sides of the liquid crystal layer 2. Specifically, an alignment film may be provided on the first electrode 4, and an alignment film may be provided on the second electrode 5. By providing an alignment film, an initial alignment state of liquid crystal molecules in the liquid crystal layer 2 can be controlled, ensuring that the liquid crystal molecules can be deflected in an expected manner under an applied voltage, so as to determine a gray scale state to be either L0 grayscale state or L255 grayscale state. It is to be noted that when the liquid crystal layer 2 is made of a blue-phase liquid crystal, since alignment is not necessary for the blue-phase liquid crystal, the display panel may be provided with no alignment film.

Further, the display panel further includes gate lines, data lines and thin film transistors. The gate lines, the data lines and the thin film transistors may be located between the waveguide layer 3 and the second electrode 5. Each thin film transistor includes a gate, an active layer, a source and a drain, and the second electrode 5 is connected to the drain of the thin film transistor. The gate lines, the data lines and the thin film transistors are not shown in FIG. 1.

When the absolute value of the difference between the refractive index of the waveguide layer 3 and the refractive index of the liquid crystal layer 2 is a first set difference value, the amount of light coupled out of the waveguide layer 3 is a set amount, so that the display panel is in L255 grayscale state. The first set difference value is a minimum difference value, the set amount is a maximum amount, and the liquid crystal layer 2 can prevent total reflection of light in the waveguide layer 3 to the utmost extent, so that the amount of light coupled out of the waveguide layer 3 is maximum, and thus the display panel is in L255 grayscale state.

When the absolute value of the difference between the refractive index of the waveguide layer 3 and the refractive index of the liquid crystal layer 2 is a second set difference value, the amount of light coupled out of the waveguide layer 3 is zero, so that the display panel is in L0 grayscale state. The second set value is a maximum difference value, and light is totally reflected in the waveguide layer 3, with no light being coupled out of the waveguide layer 3, and thus the display panel is in L0 grayscale state.

When the absolute value of the difference between the refractive index of the waveguide layer 3 and the refractive index of the liquid crystal layer 2 is larger than the first set difference value but smaller than the second set difference value, the amount of light coupled out of the waveguide layer 3 is larger than zero but smaller that the set amount, so that the display panel is in a grayscale state between the L0 grayscale state and the L255 grayscale state. In this case, the amount of emergent light is between zero and the maximum amount, so that the display panel is in an intermediate grayscale state. By adjusting the difference between the refractive index of the waveguide layer 3 and the refractive index of the liquid crystal layer 2, the display panel can be in different grayscale states.

It should be noted that: the term “grayscale” means that brightness between the brightest and the darkest is divided into a plurality of levels, levels of different brightness from the darkest to the brightest are represented by grayscales, and more levels means more delicate picture effect that can be presented. 256 grayscales can display 256 levels of brightness and may include 256 grayscale levels from L0 grayscale to L255 grayscale.

In this embodiment, the display panel includes a plurality of pixel units, and each of the plurality of pixel units includes a plurality of grating structures 7. The grating structures 7 in each pixel unit are configured to allow light having a specific wavelength among light coupled out of the waveguide layer 3 to be emitted out at a specific diffraction angle, and the specific diffraction angle is determined by the grating period of the grating structures 7 in each pixel unit. FIG. 4 is a schematic diagram showing emergent light from the display panel of FIG. 1. As shown in FIGS. 1 and 4, the pixel unit may be a red pixel unit R, a green pixel unit G, or a blue pixel unit B, and the plurality of pixel units included in the display panel are red pixel units R, green pixel units G and blue pixel units B arranged sequentially. For a red pixel unit R, light having a specific wavelength to be displayed is red light, light coupled out of the waveguide layer 3 is irradiated onto the grating structures 7 in the red pixel unit R, the grating period of the grating structures 7 in the red pixel unit R determines a red light diffraction angle, and red light can be emitted out at the red light diffraction angle and enters into human eyes, whereas light having other wavelengths emitted out at other diffraction angles, for example, green light and blue light, will not be irradiated into human eyes, so that the red pixel unit R appears red. For a green pixel unit G, light having a specific wavelength to be displayed is green light, light coupled out of the waveguide layer 3 is irradiated onto the grating structures 7 in the green pixel unit G, the grating period of the grating structures 7 in the green pixel unit G determines a green light diffraction angle, and green light can be emitted out at the green light diffraction angle and enters into human eyes, whereas light having other wavelengths emitted out at other diffraction angles, for example, red light and blue light, will not be irradiated into human eyes, so that the green pixel unit G appears green. For a blue pixel unit B, light having a specific wavelength to be displayed is blue light, light coupled out of the waveguide layer 3 is irradiated onto the grating structures 7 in the blue pixel unit B, the grating period of the grating structures 7 in the blue pixel unit B determines a blue light diffraction angle, and blue light can be emitted out at the blue light diffraction angle and enters into human eyes, whereas light having other wavelengths emitted out at other diffraction angles, for example, red light and green light, will not be irradiated into human eyes, so that the blue pixel unit B appears blue.

The diffraction angle of light having a specific wavelength is determined by a grating period of the grating structures in each pixel unit. As shown in FIGS. 1 and 4, it can be known from the formula

$$2 sin ( \frac{θ}{2} ) = \frac{λ}{Λ}$$

that in a case where a specific wavelength λ (color) of light to be displayed by one pixel unit is determined, a specific diffraction angle θ of emergent light is determined by the grating period Λ of the grating structures 7 in the pixel unit. Description is given by taking a red pixel unit R in FIG. 1 as an example, the red pixel unit R needs to emit red light, that is, the specific wavelength of the emergent light is the wavelength of red light, then the specific diffraction angle θ at which red light is emitted out (i.e., the red light diffraction angle) is determined by the grating period Λ of the grating structures 7 in the red pixel unit R, under the premise that the specific wavelength λ of the emergent light is the wavelength of red light. Similarly, the specific diffraction angle θ at which green light is emitted out (i.e., the green light diffraction angle) is determined by the grating period Λ of the grating structures 7 in the green pixel unit G; and the specific diffraction angle θ at which blue light is emitted out (i.e., the blue light diffraction angle) is determined by the grating period Λ of the grating structures 7 in the blue pixel unit B. The grating period of the grating structures 7 in each pixel unit is determined by the number of the grating structures 7 in each pixel unit. It should be noted that, the number of the grating structures 7 in each pixel unit as shown in FIGS. 1 and 4 only indicates that each pixel unit includes a plurality of grating structures 7, but does not indicate the actual number of the grating structures 7 in each pixel unit.

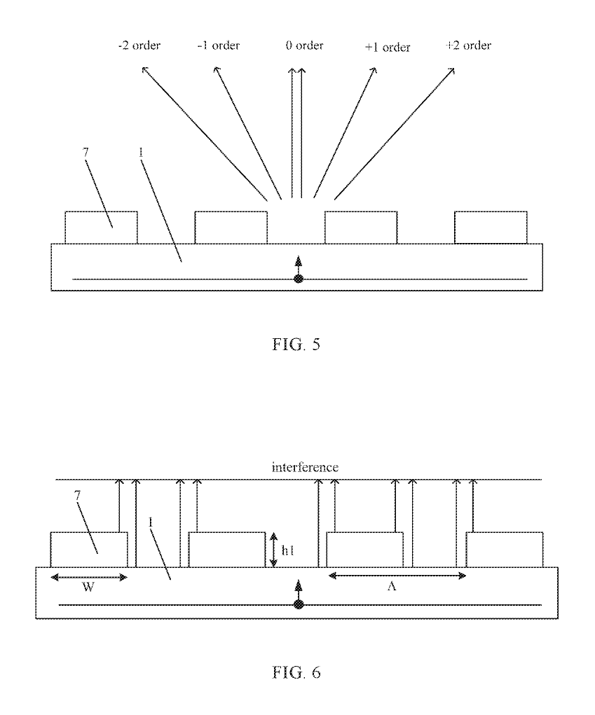

A zero-order diffraction intensity and a first-order diffraction intensity of the grating structures 7 in each pixel unit are determined according to a thickness and/or a duty ratio of the grating structures 7. FIG. 5 is a schematic diagram illustrating diffraction principle of the grating layer in FIG. 1, and FIG. 6 is a schematic diagram illustrating interference principle of the grating layer in FIG. 1. As shown in FIG. 5, light irradiated onto the grating structures 7 undergoes multi-order diffraction, and zero-order diffraction (0-order), first-order diffraction (+1 order, −1 order) and second-order diffraction (+2 order, −2 order) are shown in FIG. 6. As shown in FIG. 5, light irradiated onto the grating structures 7 also undergoes interference, and the interference may include destructive interference or constructive interference. In a case where the interference is destructive interference, h1 (n4−n5)=mλ/2, where h1 is the thickness of the grating structures 7, n4 is the refractive index of the grating structures 7, n5 is the refractive index of the planarization layer 9, and λ is the wavelength of light. For example, when n4=1.8 and n5=1.3, λ=h1/m, and when m=1, 3, 5, . . . , a transmission valley appears at the zero-order diffraction and a transmission peak appears at the first-order diffraction. In a case where the interference is constructive interference, h1 (n4−n5)=mλ, where h1 is the thickness of the grating structures 7, n4 is the refractive index of the grating structures 7, n5 is the refractive index of the planarization layer 9, and λ is the wavelength of light. For example, when n4=1.8 and n5=1.3, λ=h1/λm, and when m=1, 2, 3, . . . , a transmission peak appears at the zero-order diffraction and a transmission valley appears at the first-order diffraction. In the embodiment, a case where a transmission valley occurs at the zero-order diffraction and a transmission peak occurs at the first-order diffraction when m=1, 3, 5, . . . in the destructive interference, since white light is emitted out through the zero-order diffraction, a transmission valley may be set to occur at the zero-order diffraction such that white light cannot be transmitted through the zero-order diffraction of the grating structures 7, so as to filter out the white light. Since light having a specific wavelength is emitted out through the first-order diffraction, a transmission peak may be set to occur at the first-order diffraction, such that light having the specific wavelength can be emitted out through the first-order diffraction of the grating structures 7. It can be seen from the formula of destructive interference and constructive interference that the zero-order diffraction intensity and the first-order diffraction intensity of the grating structures 7 can be adjusted by adjusting the thickness h1 of the grating structures 7 in each pixel unit. Alternatively, the zero-order diffraction intensity and the first-order diffraction intensity of the grating structures 7 can be adjusted by adjusting the duty ratio of the grating structures 7 in each pixel unit, and the duty ratio is the ratio of a grating width W of the grating structures 7 to the grating period Λ of the grating structures 7. Alternatively, the zero-order diffraction intensity and the first-order diffraction intensity of the grating structures 7 may be adjusted by adjusting the thickness h1 and the duty ratio of the grating structures 7 in each pixel unit, so that light having a specific wavelength (color) can be emitted out at a higher efficiency (ratio). By selectively setting the zero-order diffraction intensity and the first-order diffraction intensity for light of a specific color, diffraction efficiency of light having a specific wavelength can be adjusted, so as to change the diffraction efficiency (or light output ratio) of the light of a specific color coupled out of the waveguide layer.

The display panel of the embodiment includes a first substrate, a waveguide layer, a grating layer, a first electrode and a second electrode. The first electrode and the second electrode are configured to adjust the refractive index of the liquid crystal layer by changing voltages applied thereto. The amount of light coupled out of the waveguide layer is determined according to a difference between the refractive index of the waveguide layer and the refractive index of the liquid crystal layer. The grating layer controls an emergent angle and a diffraction angle of light having a specific color in each pixel unit. In the embodiment, there is no need to provide a polarizer and color resists in the display panel, thereby improving the transmittance of the display panel. In the embodiment, since there is no need to provide a polarizer in the display panel, there is no requirement on amount of phase retardation of the entire liquid crystal layer, so that a liquid crystal cell may be set to have a smaller thickness, thereby improving response time of the liquid crystal. Since the display panel of the embodiment has high transmittance, the display panel can be applied to a transparent display product, a virtual reality (VR) product, or an augmented reality (AR) product. In the embodiment, the grating period of the grating structures 7 is small, and therefore, each pixel unit may be made small, so that the display panel can achieve high PPI display.

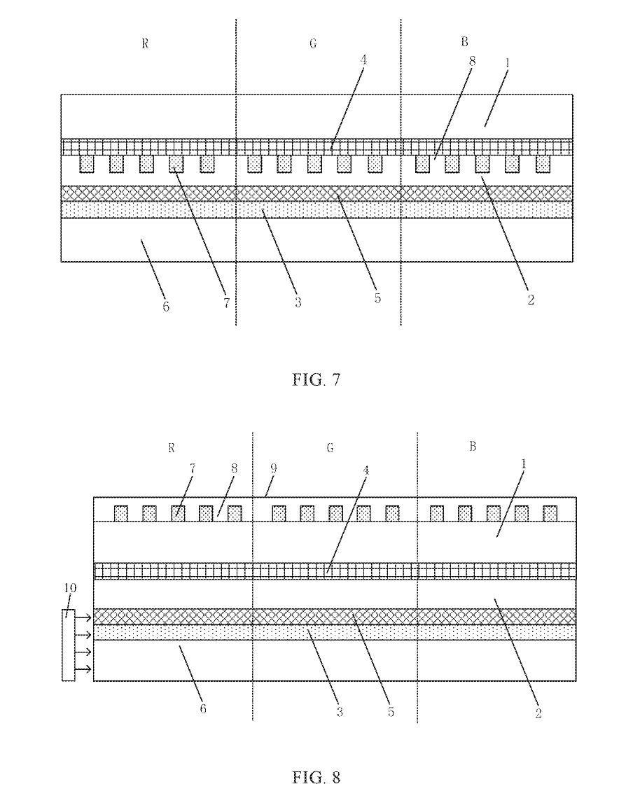

FIG. 7 is a schematic structural diagram of a display panel according to a second embodiment of the present disclosure. As shown in FIG. 7, this embodiment differs from the first embodiment in that, the second electrode 5 is on a side of the waveguide layer 3 proximal to the first substrate 1, the grating layer is on a side of the first electrode 4 proximal to the second substrate 6, the liquid crystal layer 2 is on a side of the grating layer proximal to the second substrate 6, and the first electrode 4 is on a side of the first substrate 1 proximal to the second substrate 6.

In the embodiment, the grating layer may include a plurality of grating structures 7 arranged at intervals, and the liquid crystal layer 2 covers the grating structures 7 and fills gaps 8 between the grating structures 7. The liquid crystal layer 2 has a thickness greater than that of the grating structures 7. Generally, the grating layer has a thickness smaller than or equal to 200 nm, and the liquid crystal layer 2 has a thickness greater than 200 nm and smaller than 20 μm, preferably a thickness of 1 μm. The thickness of the liquid crystal layer 2 may be set such as to be able to cover the grating structures 7 and to facilitate other parameter settings of the product (for example, electrical design, driving design, etc.). In the embodiment, the liquid crystal layer 2 is only required to have a sufficient thickness to cover the grating layer, thus, the liquid crystal layer 2 can be provided to have a very small thickness, that is, a liquid crystal cell thickness can be very small, thereby further improving response time of the liquid crystal.

In the embodiment, the liquid crystal layer 2 covers the grating structures 7 and fills the gaps 8 between the grating structures 7, and thus no planarization layer is required.

Descriptions of the other structures in the embodiment may refer to those in the first embodiment, and are not repeated herein.

The display panel of the embodiment includes a first substrate, a waveguide layer, a grating layer, a first electrode and a second electrode. The first electrode and the second electrode are configured to adjust the refractive index of the liquid crystal layer by changing voltages applied thereto. The amount of light coupled out of the waveguide layer is determined according to a difference between the refractive index of the waveguide layer and the refractive index of the liquid crystal layer. The grating layer controls an emergent angle and a diffraction angle of light having a specific color in each pixel unit. In the embodiment, there is no need to provide a polarizer and color resists in the display panel, thereby improving the transmittance of the display panel. In the embodiment, since there is no need to provide a polarizer in the display panel, there is no requirement on amount of phase retardation of the entire liquid crystal layer, so that a liquid crystal cell may be set to have a smaller thickness, thereby improving response time of the liquid crystal. Since the display panel of the embodiment has high transmittance, the display panel can be applied to a transparent display product, a virtual reality (VR) product, or an augmented reality (AR) product. In the embodiment, the grating period of the grating structures 7 is small, and therefore, each pixel unit may be made small, so that the display panel can achieve high PPI display.

FIG. 8 is a schematic structural diagram of a display device according to a third embodiment of the present disclosure. As shown in FIG. 8, the display device includes a backlight 10 and the display panel.

In the embodiment, the backlight 10 is arranged at a side of the display panel, and therefore, the backlight in the embodiment is an edge type backlight. In practical applications, a backlight in other form may also be used. For example, the backlight may be a direct type backlight, which is not specifically illustrated.

The backlight 10 may include an LED light source or a light source in another form. The LED light source may include a white LED or a light source formed by combining a red LED, a green LED and a blue LED. The light source in another form may be a laser light source, and the laser light source may be a light source formed by combining a red laser light source, a green laser light source and a blue laser light source. The light source in another form may include a CCFL lamp and a light collimation structure. Optionally, in a case where the backlight 10 is a laser light source, a beam expanding structure may be further provided on a light exiting side of the backlight 10 (i.e., between the backlight 10 and the display panel), and the beam expanding structure can not only expand laser light, as a laser point light source, emitted by the laser light source into a collimated light source, but also increase a diameter of a light beam.

The backlight 10 is provided at least correspondingly to the waveguide layer 3, and a light exiting direction of light from the backlight 10 is parallel to a plane where the waveguide layer 3 is located. As shown in FIG. 8, the backlight 10 is provided correspondingly to the second substrate 6, the waveguide layer 3 and the second electrode 5, and a width of the backlight 10 may be the sum of widths of the second substrate 6, the waveguide layer 3 and the second electrode 5. In practical applications, the backlight 10 may be set to have other width, but it is preferable that the backlight 10 does not emit light towards the liquid crystal layer 2 and layers above the liquid crystal layer 2. Since a sealant is provided on outer side of the liquid crystal layer 2, light emitted towards the liquid crystal layer 2 will not enter into the liquid crystal layer 2.

Preferably, light emitted from the backlight 10 is collimated light. In particular, when the backlight 10 is a laser light source, light emitted from the backlight 10 becomes collimated light due to the beam expanding structure. In the embodiment, light emitted from the backlight 10 may be white light.

The display device of the embodiment employs the display panel shown in FIG. 1, the detailed description of which may refer to that in the first embodiment and is not repeated herein.

Optionally, the display device of the embodiment may also employ the display panel shown in FIG. 7, the detailed description of which may refer to that in the second embodiment and is not repeated herein.

In this embodiment, the display device may be an ECB display device, a TN display device, a VA display device, an IPS display device, or an ADS display device.

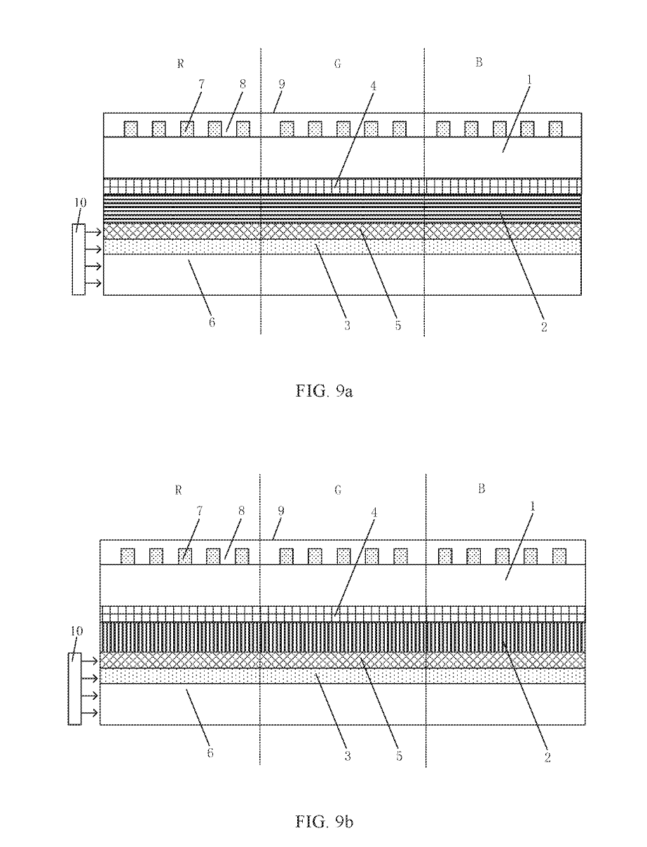

FIG. 9a is a schematic diagram of a display device, which is an ECB display device, in a display mode, and FIG. 9b is a schematic diagram of a display device, which is an ECB display device, in another display mode. As shown in FIGS. 9a and 9b, the liquid crystal layer 2 may be made of a nematic liquid crystal. As shown in FIG. 9a, the difference between the voltages applied to the second electrode 5 and the first electrode 4 is adjusted to adjust orientations of liquid crystal molecules in the liquid crystal layer 2 such that an absolute value of the difference between the refractive index of the waveguide layer 3 and the refractive index of the liquid crystal layer 2 is a first set difference value, which is a minimum difference value, in this case, the amount of light coupled out of the waveguide layer 3 is a set amount, which is a maximum amount, and thus the display device is in L255 grayscale state. As shown in FIG. 9b, the difference between the voltages applied to the second electrode 5 and the first electrode 4 is adjusted to adjust orientations of liquid crystal molecules in the liquid crystal layer 2 such that the absolute value of the difference between the refractive index of the liquid crystal layer 2 and the refractive index of the waveguide layer 3 is a second set difference value, which is a maximum difference value, in this case, the amount of light coupled out of the waveguide layer 3 is zero, and light cannot be coupled out of the waveguide layer 3, thus the ECB display device is in L0 grayscale state. It should be noted that the patterns in the liquid crystal layer 2 in FIGS. 9a and 9b merely indicate that liquid crystal molecules in the two figures are orientated differently but not intended to limit the orientations of the liquid crystal molecules.

Different display modes are described above by taking only one type of display device as an example, and display modes of other types of display devices are not listed herein one by one.

In the display device of the embodiment, the display panel includes a first substrate, a waveguide layer, a grating layer, a first electrode and a second electrode. The first electrode and the second electrode are configured to adjust the refractive index of the liquid crystal layer by changing voltages applied thereto. The amount of light coupled out of the waveguide layer is determined according to a difference between the refractive index of the waveguide layer and the refractive index of the liquid crystal layer. The grating layer controls an emergent angle and a diffraction angle of light having a specific color in each pixel unit. In the embodiment, there is no need to provide a polarizer and color resists in the display panel, thereby improving the transmittance of the display panel. In the embodiment, since there is no need to provide a polarizer in the display panel, there is no requirement on amount of phase retardation of the entire liquid crystal layer, so that a liquid crystal cell may be set to have a smaller thickness, thereby improving response time of the liquid crystal. Since the display panel of the embodiment has high transmittance, the display panel can be applied to a transparent display product, a virtual reality (VR) product, or an augmented reality (AR) product. In the embodiment, the grating period of the grating structures 7 is small, and therefore, each pixel unit may be made small, so that the display panel can achieve high PPI display.

It could be understood that the above embodiments are merely exemplary embodiments adopted for describing the principle of the present invention, but the present invention is not limited thereto. Various variations and improvements may be made by those of ordinary skill in the art without departing from the spirit and essence of the present invention, and these variations and improvements shall also be regarded as falling into the protection scope of the present invention.

1-10. (canceled)

11. A display panel, comprising a first substrate, a liquid crystal layer, a waveguide layer, a grating layer, a first electrode and a second electrode, wherein the liquid crystal layer, the first electrode and the second electrode are located between the waveguide layer and the first substrate;
the first electrode and the second electrode are configured to adjust a refractive index of the liquid crystal layer by changing voltages applied thereto; and
an amount of light coupled out of the waveguide layer is determined based on a difference between the refractive index of the liquid crystal layer and a refractive index of the waveguide layer.

12. The display panel of claim 11, further comprising a second substrate located on a side of the waveguide layer distal to the first substrate.

13. The display panel of claim 12, wherein the second electrode is on a side of the waveguide layer proximal to the first substrate, the grating layer is on a side of the first electrode proximal to the second substrate, the liquid crystal layer is on a side of the grating layer proximal to the second substrate, and the first electrode is on a side of the first substrate proximal to the second substrate.

14. The display panel of claim 13, wherein the grating layer comprises a plurality of grating structures provided at intervals, the liquid crystal layer covers the grating structures and fills gaps between the grating structures, and the liquid crystal layer has a thickness greater than a thickness of the grating structures.

15. The display panel of claim 12, wherein the second electrode is on a side of the waveguide layer proximal to the first substrate, the first electrode is on a side of the first substrate proximal to the second substrate, the liquid crystal layer is between the first electrode and the second electrode, and the grating layer is on a side of the first substrate distal to the second substrate.

16. The display panel of claim 15, further comprising a planarization layer provided on a side of the grating layer distal to the first substrate;
wherein the grating layer comprises a plurality of grating structures provided at intervals, the planarization layer covers the grating structures and fills gaps between the grating structures, and the planarization layer has a thickness greater than a thickness of the grating structures.

17. The display panel of claim 11, wherein
in a case where an absolute value of the difference between the refractive index of the waveguide layer and the refractive index of the liquid crystal layer is a first set difference value, the amount of light coupled out of the waveguide layer is a set amount, so that the display panel is in L255 grayscale state.

18. The display panel of claim 11, wherein
in a case where an absolute value of the difference between the refractive index of the waveguide layer and the refractive index of the liquid crystal layer is a second set difference value, the amount of light coupled out of the waveguide layer is zero, so that the display panel is in L0 grayscale state.

19. The display panel of claim 11, wherein
in a case where an absolute value of the difference between the refractive index of the waveguide layer and the refractive index of the liquid crystal layer is larger than a first set difference value and smaller than a second set difference value, the amount of light coupled out of the waveguide layer is larger than zero and smaller than a set amount, so that the display panel is in a grayscale state between L0 grayscale state and L255 grayscale state.

20. The display panel of claim 11, wherein the grating layer comprises a plurality of grating structures provided at intervals, the display panel comprises a plurality of pixel units, each of the plurality of pixel units comprises a plurality of grating structures, and the plurality of grating structures in each of the plurality of pixel units are configured to set an emergent angle of light having a specific wavelength by setting a grating period thereof.

21. The display panel of claim 20, wherein a zero-order diffraction intensity and a first-order diffraction intensity of the grating structures in each of the plurality of pixel units are determined according to a thickness and/or duty ratio of the grating structures.

22. A display device, comprising a backlight and the display panel of claim 11.
